(19) United States
(12) Patent Application Publication
(10) Pub. No.: US 2018/0112292 A1
(43) Pub. Date: Apr. 26, 2018

(54) NON-MAGNETIC PRECIOUS ALLOY FOR HOROLOGICAL APPLICATIONS

(71) Applicant: Nivarox-FAR S.A., Le Locle (CH)

(72) Inventors: Denis VINCENT, Neuchatel (CH); Christian Charbon, Chezard-St-Martin (CH)

(73) Assignee: Nivarox-FAR S.A., Le Locle (CH)

(21) Appl. No.: 15/729,711

(22) Filed: Oct. 11, 2017

(30) Foreign Application Priority Data
Oct. 25, 2016 (EP) 16195601.6

(51) Int. Cl. C22C 5/02; C22F 1/14; G04B 99/00; B21B 3/00; B21B 1/18; B21C 1/00

(52) U.S. Cl. CPC C22C 5/02; C22F 1/14; G04B 99/00; B21F 45/00; B21B 1/18; B21C 1/00; B21B 3/003

(57) ABSTRACT

A precious alloy for horological applications contains by mass, in parts per thousand of the total, 540 to 630 parts of gold, 150 to 220 parts of palladium, 100 to 265 parts of silver, more than 150 to 265 parts of copper, from 0.0 to 0.2 parts of iridium, 0.0 to 4.0 parts of zinc, and the remainder containing iron and/or nickel and/or cobalt. The proportion by mass of the total content of gold, palladium, silver, copper, iridium and zinc is greater than 999.900 parts, the proportion by mass of the remainder is less than 0.100 parts. The density of the alloy includes between 13.5 and 14.5 g/cm³. The proportion by mass of cobalt is less than 0.005 parts, that of iron is less than 0.005 parts, and that of nickel is less than 0.0005 parts. The total of copper and zinc includes between 150 and 270 parts.

This application claims priority from European Patent Application No. 16195601.6 filed on Oct. 25, 2016, the entire disclosure of which is hereby incorporated herein by reference.

### FIELD OF THE INVENTION

The invention concerns a precious alloy, containing, by mass, at least 540% of gold.

The invention further concerns a non-magnetic timepiece component made of this precious alloy.

The invention concerns the field of structural or external timepiece components made of 9 carat gold or higher, notably at least 13 carat gold, and in particular 14 carat gold.

### BACKGROUND OF THE INVENTION

A common feature of most precious metal alloys used in horology is their high density—higher than 10 g/cm³. In fact, the two main precious metals used in horology, gold and platinum, have respective densities of around 19.3 and 21.5 g/cm³. Consequently, this makes their alloys relatively heavy.

Often, precious alloys are manufactured in such a way as to respect legal fineness, and contain alloying elements able to provide particular qualities of colouring, colour stability over time, surface hardness, or other particular qualities. Particular attention is paid in the composition of these precious alloys to elements with the highest content in the alloy, particularly gold and platinoids. On the other hand, control of trace elements is usually much less precise than for very technical alloys, where very small proportions of certain alloying elements have a very significant effect on the performance of the alloy.

It is noted therefore that some components made of precious alloys found in commerce exhibit harmful behaviour in some circumstances, in particular in proximity to a magnetic field.

Japanese Patent JP H09 184033A in the name of TANAKA Precious Metal Inc. discloses a white gold alloy containing, by mass, 40 to 70% of gold, 10 to 20% of copper, 5 to 15% of silver, and the remainder of palladium. In a variant, the silver can be replaced with 0.5 to 5% of at least one element from among Zn, IN, Sn, Rh, Ru, Ir and Pt. Platinum may also be added to the alloy.

CH Patent 709923A2 in the name of NIVAROX discloses a white or grey gold nickel alloy containing, expressed in mass percent, 29.15 to 54.2% of gold, 1 to 15% of zinc, between 25 and 42% of copper and between 14 and 32% of nickel, and possibly a maximum of 5% of at least one element selected from among Ir, In, Ti, Si, Ga, Re.

### SUMMARY OF THE INVENTION

The invention proposes to develop precious alloys containing gold, which are suitable for the production of non-magnetic components. This issue is important in watches devised to operate normally even in proximity to high magnetic fields, notably higher than 15,000 Gauss, i.e. 1.5 Tesla.

To this end, the invention concerns a precious alloy according to claim 1.

The invention further concerns a non-magnetic timepiece component, whose constituent material is such an alloy.

The invention also concerns a method for forming a wire made of such a precious alloy, arranged to constitute the raw material for creating such components.

### BRIEF DESCRIPTION OF THE DRAWINGS

Other features and advantages of the invention will appear from reading the following detailed description, with reference to the annexed drawings, in which

FIG. 1 is a block diagram representing the steps of the method for forming a precious alloy wire, according to the invention.

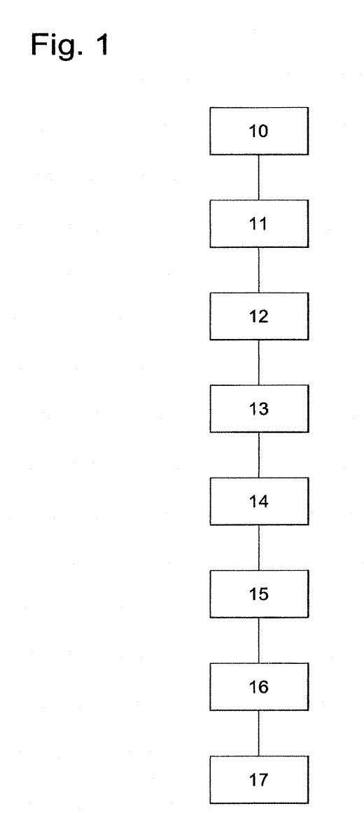

### DETAILED DESCRIPTION OF PREFERRED EMBODIMENTS

Despite the well-known benefit of cobalt in an alloy for improving mechanical properties and refining the grain of the alloy, the invention proposes to exclude it in order to obtain non-magnetic components.

Indeed, for horological applications, an alloy must conform to certain characteristics that may appear contradictory, and the definition of a suitable alloy results from a long search for compromise in the alloy composition.

In the present case, the alloy must exhibit insensitivity to magnetic fields, and therefore must not contain iron, or nickel or cobalt.

It is also sought to obtain all or part of the following characteristics:
a grey colour, resistant to tarnishing and oxidation, which leads to the incorporation of palladium and/or silver. Palladium provides good resistance to tarnishing, but its high cost means that its content must be kept to a bare minimum;
high mechanical characteristics (>250 HV), which leads to the incorporation of copper and/or palladium to promote the formation of ordered phases and structural hardening, but here too the palladium content must to kept to a strict minimum;
good machinability, with a highly work-hardened alloy, or having structural hardening, to limit elongation and promote chip breakage;
the possibility of shaping into wires of small diameter (0.3 to 2.0 mm approximately), which leads to the choice of a single-phase alloy exhibiting very high ductility in the annealed state.

The invention consists of the selection and use, for non-magnetic horological applications, of an alloy offering the best compromise between all these constraints, which is described hereinafter.

The invention therefore concerns a precious alloy for horological applications containing, by mass, expressed as parts per thousand of the total, from 540 to 630 parts of gold, from 150 to 220 parts of palladium, from 100 to 265 parts of silver, strictly more than 150 and up to 265 parts of copper, from 0.0 to 0.2 parts of iridium, from 0.0 to 4.0 parts of zinc, and the remainder containing iron and/or nickel and/or cobalt, since iron, nickel, cobalt cannot be completely avoided as trace elements, but their amount has to be at the lowest possible.

According to the invention, the proportion by mass of gold, palladium, silver, copper, iridium and zinc, is greater than 999.900 parts per thousand of the total, the proportion by mass of said remainder is less than 0.100 parts per thousand of the total, the density of the alloy is comprised between 13.5 and 14.5 g/cm³, and the proportion by mass of cobalt is less than 0.005 parts per thousand of the total, and the proportion by mass of iron is less than 0.005 parts per thousand of the total, and the proportion by mass of nickel is less than 0.005 parts per thousand of the total.

Advantageously, the alloy contains, by mass, a total copper and zinc content comprised between 150 and 270 parts per thousand of the total.

More particularly, the remainder comprises only iron and/or nickel and/or cobalt.

More particularly, the alloy contains, by mass, from 100 to 210 parts per thousand of silver.

In a variant, the alloy contains, by mass, strictly more than 180 and up to 220 parts per thousand of palladium.

In another variant, the alloy contains, by mass, from 150 to 160 parts per thousand of palladium.

More particularly still, the alloy contains, by mass, a total copper and zinc content comprised between 150 and 160 parts per thousand of the total.

More particularly, the alloy contains, by mass, a total silver and copper content comprised between 250 and 270 parts per thousand of the total.

More particularly, the alloy contains, by mass, a total palladium and copper content comprised between 300 and 320 parts per thousand of the total.

In a variant, the alloy contains, by mass, strictly more than 1.0 and up to 4.0 parts per thousand of zinc.

In another variant, the alloy contains, by mass, from 0.0 to 0.1 parts per thousand of zinc.

More particularly, the alloy contains, by mass, strictly more than 150 and up to 160 parts per thousand of copper.

More particularly, the alloy contains, by mass, from 100 to 110 parts per thousand of silver.

In another variant, the alloy contains, by mass, strictly more than 200 and up to 265 parts per thousand of silver.

More particularly, the alloy contains, by mass, strictly more than 200 and up to 210 parts per thousand of silver.

More particularly, the alloy contains, by mass, strictly more than 600 and up to 630 parts per thousand of gold.

More particularly, the alloy contains, by mass, expressed as parts per thousand of the total, from 540 to 630 parts of gold, from 150 to 160 parts of palladium, from 100 to 110 parts of silver, strictly more than 150 and up to 160 parts of copper, from 0.0 to 0.2 parts of iridium, from 0.0 to 0.1 parts of zinc, and the remainder containing iron and/or nickel and/or cobalt. The proportion by mass of the total of gold, palladium, silver, copper, iridium and zinc, is greater than 999.900 parts per thousand of the total, the proportion by mass of said remainder is less than 0.100 parts per thousand of the total, the density of the alloy is comprised between 14.0 and 14.5 g/cm³, and the proportion by mass of cobalt is less than 0.005 parts per thousand of the total, and the proportion by mass of iron is less than 0.005 parts per thousand of the total, and the proportion by mass of nickel is less than 0.005 parts per thousand of the total.

More particularly, still, in an alternative, the proportion by mass of the remainder is less than 0.010 parts per thousand of the total, and the proportion by mass of cobalt is less than 0.001 parts per thousand of the total.

In another alternative, the proportion by mass of the remainder is less than 0.010 parts per thousand of the total, and the proportion by mass of iron is less than 0.001 parts per thousand of the total.

In yet another alternative, the proportion by mass of the remainder is less than 0.010 parts per thousand of the total, and the proportion by mass of nickel is less than 0.001 parts per thousand of the total.

More particularly, the alloy is a grey gold alloy, wherein the proportion by mass of gold is comprised between 585 and 587 parts per thousand of the total, the proportion by mass of palladium is comprised between 155 and 156 parts per thousand of the total, the proportion by mass of silver is comprised between 103 and 104 parts per thousand of the total, and the proportion by mass of copper is comprised between 155 and 156 parts per thousand of the total. More particularly still, the proportion by mass of gold is comprised between 585.8 and 586.2 parts per thousand of the total, the proportion by mass of palladium is comprised between 155.1 and 155.5 parts per thousand of the total, the proportion by mass of silver is comprised between 103.4 and 103.6 parts per thousand of the total, and the proportion by mass of copper is comprised between 155.1 and 155.3 parts per thousand of the total.

The invention also concerns a non-magnetic timepiece component; the material that forms this component is a precious alloy according to the invention, in one of the compositions described above. This component is devised for an environment under a magnetic field of 15,000 Gauss, in which the component does not undergo any notable displacement detrimental to the working of the movement.

This non-magnetic component may be, but is not limited to:
an inertial oscillator element;
a balance;
a carriage for a karussel or for a tourbillon;
a pallet-lever;
a regulating screw;
an inertia weight or an inertia regulating screw for a balance.

The invention also concerns a method for manufacturing a wire made of a 13 to 15 carat gold alloy wire cast with an initial diameter less than or equal to 20 mm in order to obtain a wire having a final diameter comprised between 0.3 and 2.0 mm. The method implements the following steps:
(10) a precious alloy composition is made according to the invention and placed in solution;
(11) a bar is produced by continuous casting, whose cross-section is inscribed within a diameter of 8.0 to 20.0 mm;
(12) said as-cast bar is wire rolled in a substantially rectangular cross-section, by turning the intermediate product obtained through a quarter-turn before each wire rolling pass, and cross-section deformation is limited to a value less than or equal to 20% per pass,
(13) the cumulative deformation of the intermediate product compared to the initial cross-section of the as-cast bar is measured,
(14) the wire rolling ceases when the cumulative cross-section deformation is comprised between 60% and 75%, in order to anneal an intermediate product of intermediate cross-section at a temperature of between 600° C. and 650° C. for 20 to 30 minutes, under a reducing gas atmosphere consisting of N₂ and H₂, said annealing being followed by gas or water cooling;
(15) the elastic limit of the obtained intermediate product is measured, and all heat treatment ceases when the elastic limit is greater than or equal to 950 MPa;
(16) the wire rolling is started again with the same parameters, the cumulative deformation of the intermediate product compared to the intermediate cross-section is measured, and the wire rolling ceases when the cumulative cross-section deformation, between the cross-section of the intermediate product and the intermediate cross-section, is comprised between 60% and 75%, to perform annealing, and the wire rolling, measurement and annealing process is repeated until the desired intermediate product cross-section is reached, and an elastic limit greater than or equal to 950 MPa;
(17) the intermediate product is drawn to return the cross-section to a substantially circular profile and to obtain a section wire.

More particularly, during the wire rolling, the cross-section deformation is limited to a value less than or equal to 13% per pass.

More particularly, the number of said anneals is limited to three.

More particularly, the number of drawing passes is limited to three.

More particularly, the wire obtained by said drawing passes is re-shaped.

More particularly, the section wire is cut to length when production is complete.

1. A precious alloy for horological applications whose only constituents are taken from a group exclusively comprising gold, palladium, silver, copper, iridium, zinc, iron, nickel and cobalt, said alloy containing by mass, in parts per thousand of the total, from 540 to 630 parts of gold, from 150 to 220 parts of palladium, from 100 to 265 parts of silver, strictly more than 150 and up to 265 parts of copper, from 0.0 to 0.2 parts of iridium, from 0.0 to 4.0 parts of zinc, and the remainder to 1,000 parts containing iron and/or nickel and/or cobalt, wherein the proportion by mass of the total content of gold, palladium, silver, copper, iridium and zinc is greater than 999.900 parts per thousand of the total, wherein the proportion by mass of said remainder is less than 0.100 parts per thousand of the total, and the density of the alloy is comprised between 13.5 and 14.5 g/cm³, and wherein the proportion by mass of cobalt is less than 0.005 parts per thousand of the total, and wherein the proportion by mass of iron is less than 0.005 parts per thousand of the total, and wherein the proportion by mass of nickel is less than 0.005 parts per thousand of the total, wherein said alloy contains, by mass, a total copper and zinc content comprised between 150 and 270 parts per thousand of the total.

2. The precious alloy according to claim 1, wherein said alloy contains, by mass, from 100 to 210 parts per thousand of silver.

3. The precious alloy according to claim 1, wherein said alloy contains, by mass, strictly more than 180 and up to 220 parts per thousand of palladium.

4. The precious alloy according to claim 1, wherein said alloy contains, by mass, from 150 to 160 parts per thousand of palladium.

5. The precious alloy according to claim 1, wherein said alloy contains, by mass, a total copper and zinc content comprised between 150 and 160 parts per thousand of the total.

6. The precious alloy according to claim 1, wherein said alloy contains, by mass, a total copper and zinc content comprised between 250 and 270 parts per thousand of the total.

7. The precious alloy according to claim 1, wherein said alloy contains, by mass, a total palladium and copper content comprised between 300 and 320 parts per thousand of the total.

8. The precious alloy according to claim 1, wherein said alloy contains, by mass, strictly more than 1.0 and up to 4.0 parts per thousand of zinc.

9. The precious alloy according to claim 1, wherein said alloy contains, by mass, from 0.0 to 0.1 parts per thousand of zinc.

10. The precious alloy according to claim 1, wherein said alloy contains, by mass, strictly more than 150 and up to 160 parts per thousand of copper.

11. The precious alloy according to claim 2, wherein said alloy contains, by mass, from 100 to 110 parts per thousand of silver.

12. The precious alloy according to claim 1, wherein said alloy contains, by mass, strictly more than 200 and up to 265 parts per thousand of silver.

13. The precious alloy according to claim 12, wherein said alloy contains, by mass, strictly more than 200 and up to 210 parts per thousand of silver.

14. The precious alloy according to claim 1, wherein said alloy contains, by mass, strictly more than 600 and up to 630 parts per thousand of gold.

15. The precious alloy according to claim 1, wherein said alloy contains, by mass, in parts per thousand of the total, from 540 to 630 parts of gold, from 150 to 160 parts of palladium, from 100 to 110 parts of silver, strictly more than 150 and up to 160 parts of copper, from 0.0 to 0.2 parts of iridium, from 0.0 to 0.1 parts of zinc, and the remainder containing iron and/or nickel and/or cobalt, wherein the proportion by mass of the total content of gold, palladium, silver, copper, iridium and zinc is greater than 999.900 parts per thousand of the total, wherein the proportion by mass of said remainder is less than 0.100 parts per thousand of the total, and the density of the alloy is comprised between 14.0 and 14.5 g/cm³, and wherein the proportion by mass of cobalt is less than 0.005 parts per thousand of the total, and wherein the proportion by mass of iron is less than 0.005 parts per thousand of the total, and wherein the proportion by mass of nickel is less than 0.005 parts per thousand of the total.

16. The precious alloy according to claim 15, wherein the proportion by mass of said remainder is less than 0.010 parts per thousand of the total, and wherein the proportion by mass of cobalt is less than 0.001 parts per thousand of the total.

17. The precious alloy according to claim 15, wherein the proportion by mass of said remainder is less than 0.010 parts per thousand of the total, and wherein the proportion by mass of iron is less than 0.001 parts per thousand of the total.

18. The precious alloy according to claim 15, wherein the proportion by mass of said remainder is less than 0.010 parts per thousand of the total, and wherein the proportion by mass of nickel is less than 0.001 parts per thousand of the total.

19. The precious alloy according to claim 15, wherein the proportion by mass of gold is comprised between 585 and 587 parts per thousand of the total, the proportion by mass of palladium is comprised between 155 and 156 parts per thousand of the total, the proportion by mass of silver is comprised between 103 and 104 parts per thousand of the total, and the proportion by mass of copper is comprised between 155 and 156 parts per thousand of the total.

20. The precious alloy according to claim 19, wherein the proportion by mass of gold is comprised between 585.8 and 586.2 parts per thousand of the total, the proportion by mass of palladium is comprised between 155.1 and 155.5 parts per thousand of the total, the proportion by mass of silver is comprised between 103.4 and 103.6 parts per thousand of the total, and the proportion by mass of copper is comprised between 155.1 and 155.3 parts per thousand of the total.

21. The precious alloy according to claim 1, wherein said remainder to 1000 contains only iron and/or nickel and/or cobalt.

22. A non-magnetic timepiece component, wherein the material that forms said component is an alloy according to claim 1.

23. The non-magnetic timepiece component according to claim 22, wherein said component is an inertial oscillator element.

24. The non-magnetic timepiece component according to claim 22, wherein said component is a balance.

25. The non-magnetic timepiece component according to claim 22, wherein said component is a carriage for a karrusel or for a tourbillon.

26. The non-magnetic timepiece component according to claim 22, wherein said component is a regulating screw.

27. The non-magnetic timepiece component according to claim 22, wherein said component is an inertia-block or an inertia regulating screw for a balance.

28. A method for manufacturing a 13 to 15 carat gold alloy wire cast with an initial diameter less than or equal to 20 mm in order to obtain a wire having a final diameter comprised between 0.3 and 2.0 mm, comprising:
making a precious alloy composition according to claim 1 and placing the precious alloy composition in solution;
producing a bar by continuous casting, whose cross-section is inscribed within a diameter of 8.0 to 20.0 mm;
wire rolling said as-cast bar in a substantially rectangular cross-section, by turning the intermediate product obtained through a quarter-turn before each wire rolling pass, and cross-section deformation is limited to a value less than or equal to 20% per pass;
measuring the cumulative deformation of the intermediate product compared to the initial cross-section of said as-cast bar;
ceasing the wire rolling when the cumulative cross-section deformation is comprised between 60% and 75%, in order to anneal an intermediate product of intermediate cross-section at a temperature of between 600° C. and 650° C. for 20 to 30 minutes, under a reducing gas atmosphere consisting of N₂ and H₂, said annealing being followed by gas or water cooling;
measuring the elastic limit of the obtained intermediate product, and all heat treatment ceases when the elastic limit is greater than or equal to 950 MPa;
staring the wire rolling again with the same parameters, wherein the cumulative deformation of the intermediate product compared to the intermediate cross-section is measured, and the wire rolling ceases when the cumulative cross-section deformation, between the cross-section of the intermediate product and said intermediate cross-section, is comprised between 60% and 75%, to perform annealing, and the wire rolling, measurement and annealing process is repeated until the desired intermediate product cross-section is reached, and an elastic limit greater than or equal to 950 MPa; and
drawing the intermediate product to return the cross-section to a substantially circular profile and to obtain a section wire.
